(19) United States
(12) Patent Application Publication
(10) Pub. No.: US 2011/0111745 A1
(43) Pub. Date: May 12, 2011

(54) SYSTEMS AND METHODS FOR CELL SEARCH IN MULTI-TIER COMMUNICATION SYSTEMS

(75) Inventors: Ying Li, Gerland, TX (US); Jung Je Son, Yongin-shi (KR); Zhouyue Pi, Richardson, TX (US); Jungshin Park, Seoul (KR)

(73) Assignee: Samsung Electronics Co., Ltd., Suwon-si (KR)

(21) Appl. No.: 12/916,985

(22) Filed: Nov. 1, 2010

Related U.S. Application Data
(60) Provisional application No. 61/280,671, filed on Nov. 6, 2009.

(51) Int. Cl. H04W 4/00

(52) U.S. Cl. 455/422.1

(57) ABSTRACT

A mobile station capable of accessing a wireless network comprising a plurality of macro-base stations and a plurality of femto-base stations. The mobile station comprises: 1) a transceiver that communicates with the macro-base stations and femto-base stations; 2) a message processor coupled to the transceiver; and 3) a memory coupled to the message processor that stores a white list of CSGID values associated with at least one closed subscription group to which the mobile station subscribes. The message processor transmits to a first macro-base station a first control message that contains at least one CSGID value from the white list. The message processor receives from the first macro-base station a second control message that contains the information of at least one femto-base station (FBS) identifier associated with the at least one CSGID value. The mobile station uses the information of the at least one FBS identifier to access a first femto-base station associated with the at least one FBS identifier.

### CROSS-REFERENCE TO RELATED APPLICATION(S) AND CLAIM OF PRIORITY

The present application is related to U.S. Provisional Patent Application No. 61/280,671, filed Nov. 6, 2009, entitled “Methods And Apparatus To Flexibly Identify And Indicate Base Stations In Communication Systems”. Provisional Patent Application No. 61/280,671 is assigned to the assignee of the present application and is hereby incorporated by reference into the present application as if fully set forth herein. The present application hereby claims priority under 35 U.S.C. §119(e) to U.S. Provisional Patent Application No. 61/280,671.

### TECHNICAL FIELD OF THE INVENTION

The present application relates generally to wireless networks and, more specifically, to wireless networks that incorporate femtocell base stations.

In a wireless communication system, a channel may deteriorate due to a number of factors, including a geographical factor inside a macrocell, a distance between a mobile station (MS) and a macrocell base station (MBS), movement of the mobile station, and the like. The channel deterioration may result in a disruption of communication between the mobile station and the macrocell base station. For example, when the mobile station is located inside a structure, such as an office building or a house, a channel between the macrocell base station and the mobile station may deteriorate due a shadow region that is formed by the structure. A shadow region formed within the structure is hereafter referred to as an indoor shadow region. The mobile station located in the indoor shadow region may not be able to adequately perform communication with the macrocell base station. Further, a macrocell base station may have inadequate capacity to service all users in its macrocell.

To address the shortcomings of the macrocell base station, a variety of other base stations have been proposed, including a relay, picocell, microcell, femtocell, ubicell, and the like. The communication network thus becomes a multi-tier communication system, which has larger cell (such as macrocell) overlaying smaller cells (such as picocell, femtocell, etc.). The femtocell concept, as an example of a BS overlaid by an MBS, will be explained further below.

The IEEE 802.16m System Requirements document describes the femto-base station, which is a low-power base station (BS) that is typically installed by a person (or subscriber) in his or her home or small office/home office (SOHO). A femto-base station serves a femtocell that provides wireless access to mobile stations operated by a closed group or an open group of subscribers, as configured by the subscriber and/or the wireless access provider. A femto-base station (FBS) typically operates in licensed spectrum and may use the same or a different frequency as a macrocell base station. The FBS may use a broadband connection, such as cable or DSL, for backhaul. A mobile station that accesses a femtocell is typically stationary or moving at low speed (e.g., pedestrian).

The present disclosure incorporates by reference the following prior art documents:

1) IEEE 802.16m-07/002r8 Standard, IEEE 802.16m System Requirements Document (SRD);

2) IEEE 802.16m-08/003r7 Standard, IEEE 802.16m System Description Document (SDD);

3) IEEE 802.16 Standard, Rev. 2-D9, January 2009;

Each of the prior art references 1-3 above is hereby incorporated by reference into the present disclosure as if fully set forth herein.

A femtocell is the area served by a femto-base station (FBS). A macrocell is the area served by a macro-base station (MBS). One example of a macro-base station is a base station in a cellular network (e.g., GSM, CDMA, OFDM, OFDMA, LTE, 4G etc.). The air interface requirements of a femtocell are different from the requirements of a macrocell. By way of example, the IEEE 802.16m System Requirements document states the following with respect to femtocells: “The air interface shall support features needed to limit [mobile stations] scanning, access and handover to femtocell [base stations] with restricted access if they are designated as part of closed subscription group (CSG). The air interface shall support preferred access and handover of [mobile stations] to their designated [femto-base stations]. The air interface shall allow dense deployment of large number of femtocells by an operator.”

However, the femtocell requirements above are not applicable to macrocells. Thus, one important task is to identify femto-base stations in order to distinguish femtocells from macrocells and to distinguish an open-access femtocell (which provides access to any MS) from a CSG femtocell (which provides access only to authorized mobile stations, i.e., mobile stations belonging to the femtocell). This is important because some operations (e.g., handover, paging, etc.) are different for femtocells and macrocells and for open-access and CSG femtocells. For instance, a mobile station (MS) moving at high speed may not need to handover to any femtocells. Also, an open-access femto-base station may accept a handover request from a mobile station, while a mobile station that does not belong to a CSG femtocell may not send a handover request to that CSG femtocell.

A CSG femtocell provides a CSG identifier, called CSGID, to a mobile station to enable the mobile station to determine whether the mobile station may access a particular CSG femtocell. Even if a mobile station knows a femtocell is a particular type of CSG, the mobile station must also know whether that particular femtocell is closed or open to the mobile station. To do this, the mobile station may configure and store a “white list” of CSG femtocells which the mobile station can access, as described in the IEEE 802.16m System Description document incorporated above. When the mobile station receives the CSGID of a CSG femtocell, the mobile station then compares the received CSGID with the white list of accessible femtocells. If the received CSGID matches a CSGID stored in the mobile station white list of accessible femtocells, the mobile station knows the CSG is accessible. Thus, a CSGID of the CSG femtocell should be sent wirelessly to mobile stations. However, to make the list of accessible CSG femtocells of a mobile station short, multiple CSG femtocells may share a common CSGID if the CSG femtocells have a common set of mobile stations that are allowed to access the multiple CSG femtocells.

Another method for a mobile station to determine if a CSG femtocell is accessible is for the mobile station to store a globally unique base station ID (BSID) in a whitelist of subscribed CSG femtocells. Note that a globally unique femto base station ID may be needed for a mobile station to access a femtocell securely and for some other purposes, as described in IEEE 802.16 Standard, Rev. 2-D9, January 2009, incorporated above. If the mobile station stores a globally unique femto base station ID, it may keep a very long list if the mobile station subscribes to a membership in a chain store (e.g., Starbucks) that may have thousands of femtocells throughout the world.

Thus, the CSGID value could be used to shorten the white list in the mobile station. The CSGID value can provide easy management. For the example of a mobile station subscribing a membership to a large chain store, when the chain store installs a new femtocell in a newly opened store, if a CSGID value was not used, the chain store must ask the local cellular operator to update by adding the new femtocell to the white list of all subscribers. However, if a CSGID value is used, such an update is not needed.

In a multi-tier network, it is challenging for a mobile station to find out to which femtocells among many femtocells the mobile station is subscribed. To search for a femtocell to which the mobile station is subscribed, a mobile station may perform a search as follows. The mobile station may obtain the synchronization channel of the CSG femtocell and obtain and decode the broadcast channel, where the mobile station can get the CSGID of the CSG femtocell. Then, the MS compares the received CSGID with the stored CSGID(s) in the whitelist. If the received CSGId is in the whitelist, then the detected femtocell is one of the CSG cells to which the mobile station is subscribed. The entire cell search procedure is time and power consuming, especially when there are many nearby femtocells to which the mobile station is not subscribed. Thus, the mobile station may perform many cell search procedures before the mobile station finds a subscribed femtocell base station.

To help the mobile station to find subscribed femtocells, there is a need in the art for efficient cell search in multi-tier communication systems.

### SUMMARY OF THE INVENTION

A mobile station capable of accessing a wireless network comprising a plurality of macro-base stations and a plurality of femto-base stations is provided. The mobile station comprises: 1) a transceiver capable of communicating with the macro-base stations and femto-base stations of the wireless network; 2) a message processor coupled to the transceiver; and 3) a memory coupled to the message processor that stores a white list of CSGID values associated with at least one closed subscription group to which the mobile station is subscribed. The message processor is operable to transmit to a first macro-base station a first control message that contains at least one CSGID value from the white list. The message processor is further operable to receive from the first macro-base station a second control message that contains the information of at least one femto-base station (FBS) identifier associated with the at least one CSGID value. The mobile station uses the information of the at least one FBS identifier to access a first femto-base station associated with the at least one FBS identifier.

A macro-base station for use in a wireless network capable of communicating with a plurality of mobile stations in a coverage area of the wireless network is provided. The macro-base station is capable of receiving from a first mobile station a first control message that contains at least one CSGID value from a white list of CSGID values associated with at least one closed subscription group to which the first mobile station is subscribed. The macro-base station, in response to the first control message, is further capable of transmitting to the first mobile station a second control message that contains the information of at least one femto-base station (FBS) identifier associated with the at least one CSGID value.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that performs cell searching according to the principles of the present disclosure;

FIG. 2 illustrates a plurality of femtocells that are within the coverage area of macro-base stations according to the principles of the present disclosure;

FIG. 3 illustrates a mobile station that maintains a white list of CSGID values according to an exemplary embodiment of the disclosure;

FIG. 4 illustrates an exemplary operation of cell searching or cell scanning according to one embodiment of the disclosure;

FIG. 5 is a message flow diagram illustrating communication between a macro-base station and a mobile station to optimize the mobile station search according to an exemplary embodiment of the disclosure;

FIG. 6 is a flow diagram illustrating an operation in which a mobile station optimizes the search for femtocell(s) to which the mobile station subscribes according to an exemplary embodiment of the disclosure;

FIG. 7 is a flow diagram illustrating an operation in which a macro-base station enables a mobile station to optimize the search for femtocell(s) to which the mobile station subscribes among all the subscriptions of the mobile station according to an exemplary embodiment of the disclosure; and

FIG. 8 is a flow diagram illustrating an operation in which a mobile station accesses a campus femtocell according to an exemplary embodiment of the disclosure.

### DETAILED DESCRIPTION OF THE INVENTION

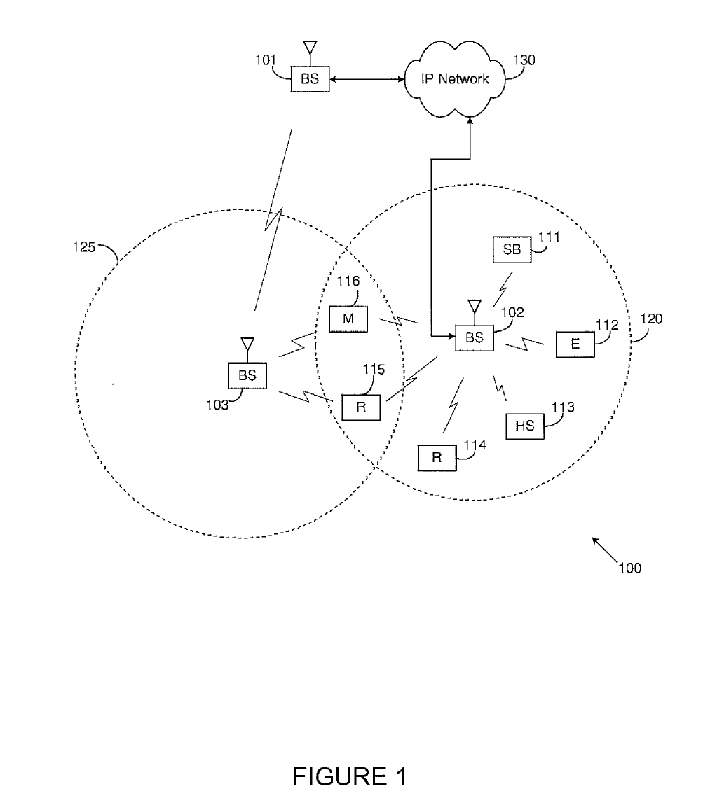

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The present disclosure describes methods and apparatuses for efficient cell search in multi-tier communication systems.

Exemplary embodiments of the present invention described below relate to techniques for cell search in multi-tier communication systems. It should be understood that the following description might refer to terms utilized in various standards merely for simplicity of explanation. For example, the following description may refer to terms utilized in the Institute of Electrical and Electronics Engineers (IEEE) 802.16m standard or the 3rd Generation Partnership Project (3GPP) Long Term Evolution (LTE) standard. However, this description should not be interpreted as being limited to the IEEE 802.16m or 3GPP LTE standards.

As used herein, the terms “cell” and “base station” (BS) may be used interchangeably.

Herein, a multi-tier communication system refers to a system where larger cells may overlay smaller cells. The present disclosure supports the coexistence of small, low-power cells (such as a femtocell, picocell, hot zone, relay, etc.) and larger base stations, such as macrocells, which may overlay the small cells. Throughout the disclosure, a femtocell is used as an example of a small, low-power base station and an macrocell is used as an example of the larger base station that may overlay the smaller base station.

Herein, the term “femtocell” may be used interchangeably with the term “femtocell base station (FBS)”, “femto”, and “femto-base stations”. The term “macrocell” may be used interchangeably with the term “macrocell base station (MBS)”. A mobile station (MS) may also be referred to as an Advanced Mobile Station (AMS), a base station (BS) may also be referred to as a Advanced Base Station (ABS), and Advanced Air Interface (AAI) may be referred to as an air interface of a communication system.

All of the exemplary embodiments of the present invention are applicable to any type or size of the base stations in multi-tier communication systems, where larger cells may overlay smaller cells.

Small, low-power cells, such as femtocells, are different from larger cells, such as macrocells. The multi-tier network, with base stations of various types and sizes, may have the capability to identify a femto-base station (FBS) as well as to distinguish femtocells from macrocells. Further, the multi-tier network may have the capability to distinguish an open-access FBS (which allows any compatible mobile station to access) from a Closed Subscription Group (CSG) FBS (which allows only authorized mobile stations, i.e., the mobile stations belonging to an FBS, to access). Some operations, such as, but not limited to, handover, paging, and the like, are different for FBS and MBSs, and for open-access and CSG FBSs. For example, a mobile station moving at high speed may not need to handover to an FBS, an open-access FBS may accept the handover requests from a mobile station, a mobile station that does not belong to a CSG FBS may not need to send a handover request to that FBS, and so forth.

The exemplary embodiments of the present invention are not limited to femtocells, although femtocells are described herein as examples of small, low-power cells. Examples of other small, low-power cells include picocells, hot zone cells, small relay cells, and the like. In addition, the exemplary embodiments are not limited to macrocells, although macrocells are described herein as examples of larger cells that may cover or overlay smaller cells within the coverage area of the larger cell.

The exemplary embodiments of the present invention may be used with any type or sized base station with some level of accessibility differentiation, such as being open to all mobile stations (e.g., an open BS), being open to limited (or authorized or subscribed) mobile stations (e.g., a CSG-closed BS), or being open to all mobile stations but with limited (or authorized or subscribed) mobile stations having higher priority and other mobile stations having lower priority (e.g., a hybrid BS, or CSG-open BS), and so forth. CSG femto-cells may include CSG-open and CSG-closed femtocells. CSG femtocells can have SCGIDs. The concept of the CSG is not limited to femtocells, but may also be applicable to other base stations, such as microcells, picocells, relays, and the like.

In this disclosure, a limited number and types of base stations, a limited number of mobile stations, or limited use cases may be described as an example. The exemplary embodiments of the present invention disclosed herein are also applicable to an arbitrary number and types of base stations, an arbitrary number of mobile stations, and other related use cases.

As used herein, a “preamble” is a sequence transmitted by a base station that may be used by a mobile station to differentiate base stations in a local neighborhood. The preamble is typically transmitted in a synchronization channel (Sync CH). A mobile station obtaining a preamble is typically the first step in cell search or cell detection. The word “preamble” is interchangeable with “cell identifier” (cell ID), “Physical layer Cell IDentifier (PCID)”. Preamble (or cell ID, PCID) may be referred to by different names in different systems. Preambles are usually assigned to the cells such that in a physical or geographic neighborhood of a mobile station, each cell may be differentiated by the preamble. Preamble and sync channel can be also measured by the mobile station so that the mobile station may measure the signal strength of the detected cell.

In a system, preambles may be partitioned into sets, with each set of the preambles to be used by one type of base station. For example, the preambles may be partitioned so that one group of preambles are used by macrocells and another group of preambles are used by femtocells. The group of preambles used by femtocells may be further partitioned into three groups, one each for CSG-closed, CSG-open, and open femtocells, respectively.

In a multi-tier system, a macrocell coverage may overlay many femtocells. When there are fewer preambles assigned to the femtocells than the number of femtocells in a macrocell, preambles may be reused by the femtocells in a macrocell, as long as in the geographic neighborhood of a mobile station, each femtocell has a different preamble so that the mobile station can differentiate the nearby femtocells. When a macrocell receives a mobile station report on the detected preamble of a femtocell, the macrocell may be able to identify the correct femtocell because there may be multiple femtocells with the same preamble in the macrocell coverage. Therefore, a unique identifier of the femtocell may be needed for the macrocell to understand which femtocell the mobile station is reporting. The unique identifier of the femtocell may be the base station identifier or some other identifier, which is explained later.

As used herein, a “Broadcast Channel” (BCH) is a control channel that a base station uses to broadcast at least some important system information. For example, in an OFDM-based, multiple-input, multiple-output (MIMO) wireless system, the BCH often carries information about system bandwidth, antenna configuration, configuration of other control channels, and other critical system configurations. A mobile station must correctly detect the BCH of a base station in order to establish further communication with that base station. The BCH may be referred to by different names in different systems.

As used herein, an “operator ID” is an identifier that identifies the operator of the base station. For example, in IEEE 802.16 systems, the operator ID is a 24-bit sequence. Operator ID may be referred to by different names in different systems.

As used herein, a “base station identifier” (or BSID) is a globally unique identifier of a base station. For example, in IEEE 802.16 systems, the BSID value for every base station (including femto-BSs) is 48 bits, wherein the most significant bits (MSB) (e.g., 24 bits) are the operator ID and the least significant bits (LSB) (e.g., 24 bits) are denoted as BSID_LSB. A BSID value may be referred to by different names in different systems. A BSID is typically broadcasted over the BCH channel of the base station, so that when the mobile station receives the BSID, the mobile station recognizes the base station uniquely. The BSID of the femtocell may be reported by the mobile station to the overlaying macrocell, so that the macrocell correctly identifies which femtocell the mobile station is reporting, without ambiguity. The BSID is typically also used for the security protocol, such as in authentication key generation. The BSID can be a logical identifier, and can be assigned by the operator to the base station.

As used herein, a “closed subscription group ID” (CSGID) is a common identifier used by a group of femto-base stations belonging to the same closed subscription group (CSG). Both CSG-closed and CSG-open (hybrid) femtocells may have CSGID values. In this disclosure, the term “CSG femtocell” may refer to both CSG-closed and CSG-open femtocells. The CSGID may be referred to by different names in different systems. The CSGID may be a globally unique identifier (ID) that identifies a closed subscription group. For example, if a chain store (Store A) buys femtocells and a mobile station subscribes to membership in the CSG of Store A, then all the femtocells belonging to Store A may be in one subscription group, with one CSGID. Thus, Store A (e.g., Starbucks) may have many locations distributed across many macrocells, but all store femtocslls share a common CSGID. Other businesses may operate a campus location in which multiple femtocells are installed. If a mobile station subscribes to the service of the campus, then all the femtocells belonging to the campus may be in one subscription group identified by one CSGID. Usually, the wireless network operator decides how to assign CSGID values to the business, enterprise, campus, etc.

The CSGID typically is a logical identifier and is independent of the preamble (i.e., the physical cell identifier usually assigned to the cells) such that in a physical or geographic neighborhood of a mobile station, each cell could be differentiated by the preamble. However, the CSGID is meant to identify the logical membership or subscription.

As used herein, a “white list” in a mobile station is a list of identifiers of CSG femto-base stations that the mobile station is allowed to access. The mobile station is subscribed to the femto-base stations identified by the identifiers in the white list. A white list may be referred to by different names in different systems. In the whitelist, the mobile station stores CSGID values of those CSGs to which the mobile station subscribes. For example, a mobile station may store the CSG identifier of the Store A femtocells if the mobile station subscribes to Store A membership. Thus, the CSGID of the Store A femtocells may be written into the whitelist of the mobile station when the mobile station subscribes to Store A membership. When the mobile station cancels a membership with Store A, the whitelist would be updated by removing the CSGID of Store A from the whitelist.

Alternatively, all the BSIDs of all the femtocells belonging to Store A in the whitelist may be written or removed when a mobile station subscribes or cancels the membership of Store A. However, writing all the BSIDs of every femtocell within Store A in the whitelist would consume a lot of memory and would be difficult for the updating of the whitelist. For example, when Store A adds or removes a femtocell, all of its member write or removes would have to update their whitelist by adding or removing a BSID of the femtocell. Hence, it is preferable to have CSGID value in the whitelist, particularly when a CSGID value has lots of femtocells within it.

FIG. 1 illustrates exemplary wireless network 100 that performs cell searching according to the principles of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Depending on the network type, other well-known terms may be used instead of “base station,” such as “eNodeB” or “access point”. For the sake of convenience, the term “base station” shall be used herein to refer to the network infrastructure components that provide wireless access to remote terminals. More particularly, each of BS 101, BS 102 and BS 103 is a macro-base station (MBS) that covers a relatively large area (or macrocell).

Base station 102 provides wireless broadband access to IP network 130 (i.e., the Internet) to a first plurality of mobile stations within coverage area 120 of base station 102. BS 102 has a wireline backhaul to IP network 130. The first plurality of mobile stations includes mobile station (MS) 111, mobile station (MS) 112, mobile station (MS) 113, mobile station (MS) 114, mobile station (MS) 115 and mobile station (MS) 116. In an exemplary embodiment, MS 111 may be located in a small business (SB), MS 112 may be located in an enterprise (E), MS 113 may be located in a WiFi hotspot (HS), MS 114 may be located in a first residence (R), MS 115 may be located in a second residence, and MS 116 may be a mobile (M) device.

For sake of convenience, the term “mobile station” is used herein to designate any remote wireless equipment that wirelessly accesses a base station, whether or not the mobile station is a truly mobile device (e.g., cell phone) or is normally considered a stationary device (e.g., desktop personal computer, vending machine, etc.). Other well-known terms may be used instead of “mobile station”, such as “subscriber station (SS)”, “remote terminal (RT)”, “wireless terminal (WT)”, “user equipment (UE)”, and the like.

Base station 103 provides wireless broadband access to IP network 130 to a second plurality of mobile stations within coverage area 125 of base station 103. BS 103 has a wireless backhaul to IP network 130. The second plurality of mobile stations includes mobile station 115 and mobile station 116.

In other embodiments, wireless network 100 may include either fewer or more base stations. It is noted that mobile station 115 and mobile station 116 are on the edge of both coverage area 120 and coverage area 125. Mobile station 115 and mobile station 116 each communicate with both base station 102 and base station 103 and may be said to be operating in handoff mode, as known to those of skill in the art.

In an exemplary embodiment, base stations 101-103 may communicate with each other and with mobile stations 111-116 in at least the downlink using orthogonal frequency division multiplexing (OFDM) protocol, according to the proposed 3GPP LTE standard, or an equivalent advanced 3G or 4G standard.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the mobile stations, weather conditions, and other factors. In an embodiment, the radius of the coverage areas of the base stations, for example, coverage areas 120 and 125 of base stations 102 and 103 may extend in the range from less than 2 kilometers to about fifty kilometers from the base stations.

As is well known in the art, a base station may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

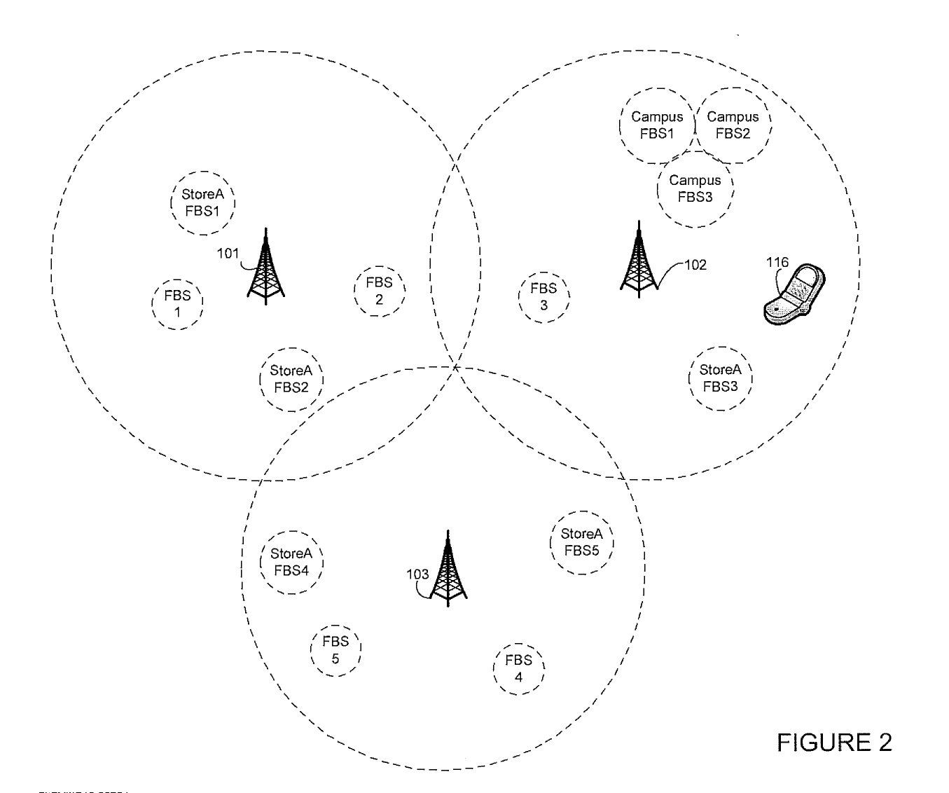

In a preferred embodiment, the coverage areas of one or more of macro-base stations 101-103 may include one or more femto-base stations. FIG. 2 illustrates a plurality of femto-base stations that are within the coverage area of base stations 101-103 according to the principles of the present disclosure. The coverage areas of macro-base stations 101-103 are indicated by large dotted-line circles. The femtocells associated with the femto-base stations are indicated by small dotted lines circles. For convenience, the femto-base stations within the femtocells are not shown. MS 116 is assumed to be moving and may be in communication with any one of macro-base stations 101-103. At some point, MS 116 may attempt to handoff to one of the neighboring femto-base stations which has the CSGID values in the white list stored in MS 116.

Four exemplary femto-base stations (FBSs) are depicted within the coverage area of macro-BS 101: Store A FBS1, Store A FBS2, FBS1 and FBS2. Store A FBS1 and Store A FBS2 are femto-base stations operated by a large chain store (e.g., Starbucks) that share a common CSGID. FBS1 and FBS2 may be individual femto-base stations operating in homes or offices.

Five femto-base stations (FBSs) are depicted in the coverage area of macro-BS 102: Store A FBS3, FBS3, Campus FBS1, Campus FBS2, and Campus FBS3. Store A FBS3 is another femto-base stations operated by the large chain store. Store A FBS3 shares a common CSGID with Store A FBS1 and Store A FBS2. FBS3 may be an individual femto-base station operating in a home or office. Campus FBS1, Campus FBS2 and Campus FBS3 are femto-base stations that are operated by a single entity and are deployed near each other in a relatively large facility. Campus FBS1, Campus FBS2 and Campus FBS3 share a common CSGID. By way of example, Campus FBS1, Campus FBS2 and Campus FBS3 may be deployed throughout a large manufacturing plant or across multiple floors of a large office building. Alternatively, Campus FBS1, Campus FBS2 and Campus FBS3 may be deployed across the grounds of a large university campus.

Four exemplary femto-base stations (FBSs) are depicted within the coverage area of macro-BS 103: Store A FBS4 and Store A FBS 5, FBS4 and FBS5. As before, Store A FBS1 and Store A FBS2 are femto-base stations operated by the large chain store. Store A FBS4 and Store A FBS5 share a common CSGID with Store A FBS1, Store A FBS2 and Store A FBS2. FBS4 and FBS5 may be individual femto-base stations operating in homes or offices.

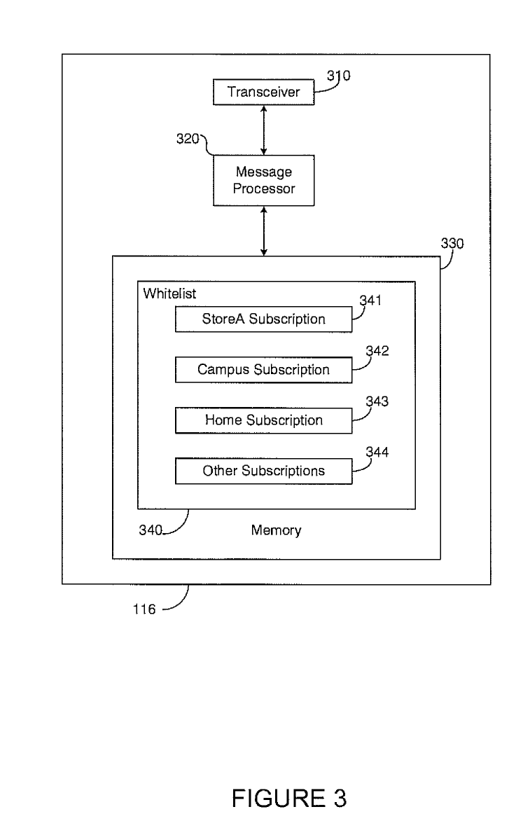

FIG. 3 illustrates mobile station 116, which maintains a white list of CSGID values according to an exemplary embodiment of the disclosure. MS 116 comprises transceiver block 310, message processor 320, and memory 330. Whitelist 340 is stored in memory 330. As noted above, whitelist 340 comprises, among other things, the CSGID values of closed subscription groups (CSGs) to which MS 116 is subscribed. By way of example, whitelist 340 stores Store A subscription data 341, campus subscription data 342, home subscription data 343, and other subscriptions data 344.

During routine operation, message processor 320 uses transceiver block 310 to transmit to, for example, macro-BS 102 and to receive from macro-BS 102. Message processor 320 transmits and receives control messages and data messages. According to the principles of the present disclosure, message processor 320 is capable of retrieving CSGID values from whitelist 340 and inserting the CSGID values (as explained further below) into special purpose data fields in control messages that are transmitted to macro-BS 102 (or BS 101, BS 103, etc.). Message processor 320 is further capable of receiving from BS 102 control messages that identify femto-base stations associated with the CSGID values from whitelist 340. By way of example, message processor 320 may receive from BS 102 control messages that contain BSID values for the femto-base stations.

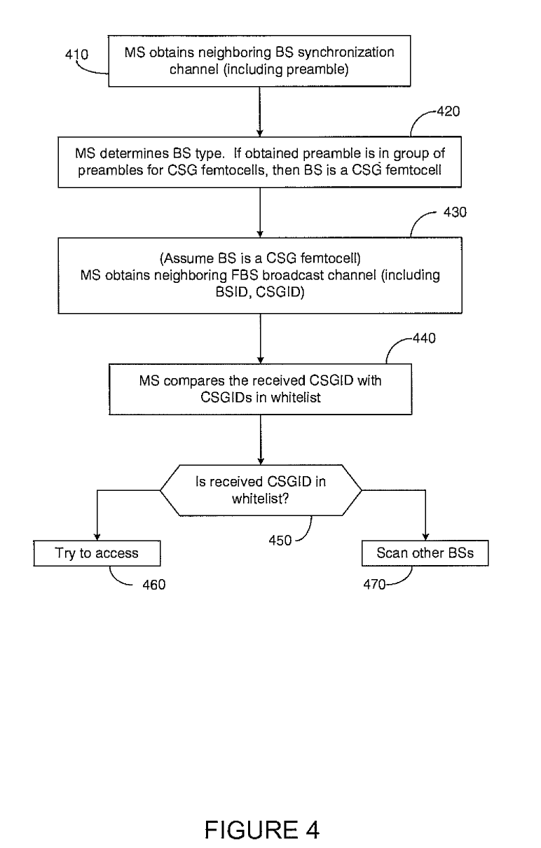

FIG. 4 illustrates an exemplary operation of cell searching or cell scanning according to one embodiment of the disclosure. Initially, a mobile station (e.g., MS 116) obtains (or detects) the synchronization (SYNC) channel of a neighboring base station. This includes going to a certain carrier operating frequency and obtaining the preamble (or the cell ID) of the base station (step 410). Based on the received preamble, MS 116 determines the type of the base station (i.e., macro-BS, CSG femto-BS, open femto-BS, etc.) based on the partition or group of the preambles (step 420). If the received preamble is in a group of preambles associated with CSG femtocells, then the base station is a CSG femtocell (i.e., CSG femto-BS).

Assuming the detected neighboring base station is a CSG femto-BS (FBS), MS 116 obtains (or detects) the broadcast channel of the neighboring femto-BS (step 430). This includes obtaining the BSID value, which is the globally unique identifier of the base station, and the CSGID value (if the BS is a CSG femto-BS), which is the identifier of the closed subscription group to which the femto-BS belongs.

MS 116 then compares the received CSGID value with CSGID values in whitelist 340 of MS 116 (step 440). If the received CSGID value is in the whitelist (“Yes” in step 450), MS 116 is subscribed to the CSG and MS 116 may try to access the femto-BS, if needed (step 460). Otherwise (“No” in step 450), MS 116 may scan other cells (step 460).

The entire cell search procedure for a mobile station to search for CSG femtocells to which the MS is subscribed is time and battery consuming, especially when there are many femtocells around which are not subscribed by the mobile station. The mobile station may attempt many cell search procedure before the mobile station finds a subscribed one. To help the mobile station to find its subscribed femtocells, there is a need in the art for efficient cell search in multi-tier communication systems.

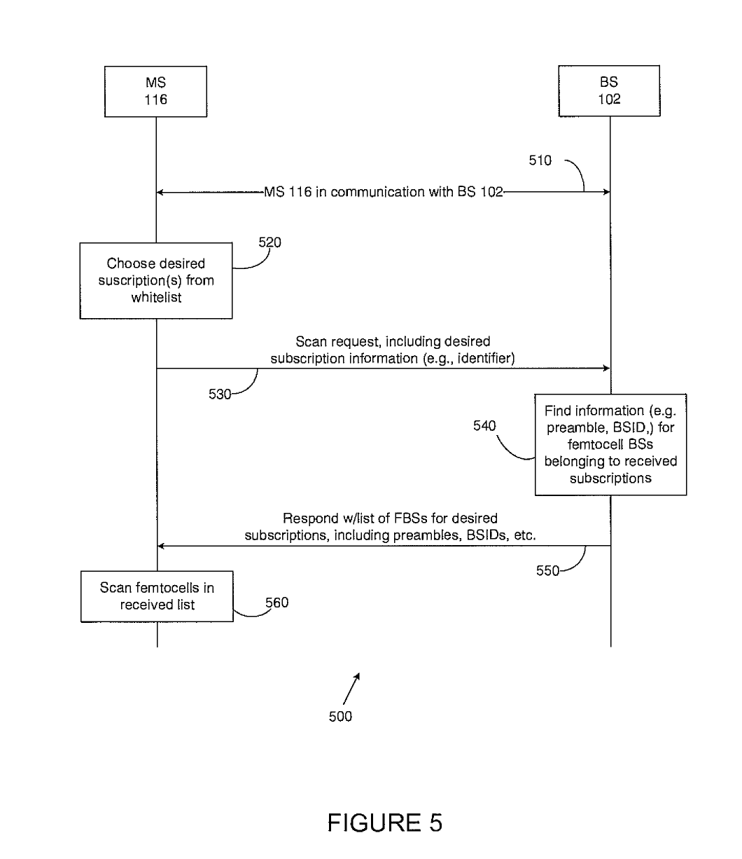

FIG. 5 depicts message flow diagram 500, which illustrates communication between macro-base station (BS) 102 and mobile station (MS) 116 according to an exemplary embodiment of the disclosure. Initially, BS 102 and MS 116 are in communication with each other (step 510). At some point, MS 116 decides to scan for femto-base stations and chooses subscription data from one or more desired subscriptions in whitelist 340 (step 520).

MS 116 then transmits to macro-BS 102 a control message, such as a scan request control message, that requests information regarding neighboring femto-base stations that MS 116 may access (step 530). The scan request includes the desired subscription data, such as CSGID values from whitelist 340. By way of example and not by limitation, MS 116 may transmit a scan request (SCN-REQ) message that has been modified to include data fields that contain CSGID values and other associated parameters.

In response to receipt of the scan request control message in step 530, macro-BS 102 finds (or retrieves) information for the femto-base stations belonging to the desired subscriptions received from MS 116 (step 540). By way of example, BS 102 determines the frequency allocation or carrier frequency (which is the frequency at which the femtocell(s) operate), preamble(s), BSID(s), and other parameters for femtocell(s) belonging to the received subscription from whitelist 340. The macro-BS 102 may contact the backhaul to look up the information for the femto-base stations belonging to the desired subscriptions received from MS 116 by sending the received subscription data such as CSGID values to the backhaul network. If macro-BS 102 has the information, then it does not need to contact the backhaul network. If the location of MS 116 is known, then information retrieved for the femto-base stations belonging to the desired subscriptions received from MS 116 can be further screened by not including the information of the femtocells which are far away from the MS.

Next, BS 102 responds to MS 116 by transmitting a message (e.g., a unicast or multicast message) that includes a list of information (e.g., information related to carrier frequency, such as carrier frequency or its index, information related to preambles or Cell ID, such as preamble or cell ID, index of preamble or cell ID, information related to the BSID, such as BSID, or a portion of a BSID) associated with one or more femto-base stations (FBSs) that are associated with the received CSGID values from whitelist 340 (step 550). If serving BS 102 is operating at the same frequency as the femtocell(s) in the list, then the frequency location may be omitted in the message. By way of example and not by limitation, BS 102 may transmit a control message that has been modified to include data fields that contain carrier frequency or its index, preambles, BSID values, and other associated parameters for one or more femto-base stations.

Upon receiving the message including the list of identifying information (e.g., carrier frequency or its index, preambles, BSIDs) associated with one or more femto-base stations (FBSs) that are associated with the desired CSGID values from whitelist 340, MS 116 scans for the femtocell(s) in the received list (step 560). MS 116 may first go to the carrier frequency indicated in the received list (if no carrier frequency is indicated in the received list the MS 116 may assume it is the same carrier frequency as serving BS 102) to search for the preamble indicated in the received list and to obtain the synchronization channel.

MS 116 may also perform measurement on the sync channel. Based on the measurement, MS 116 may choose some of the cells with strong signal to further obtain the broadcast channel. If the carrier frequency and preamble indicated in the received list are detected, then MS 116 may further choose to receive and decode the broadcast channel, where MS 116 may get the BSID of the detected channel, to compare with the one in the received list (which is sent in step 550). If it matches, then the detected femto-base station is one of the femto-base stations to which MS 116 is subscribed. MS 116 may also obtain the femtocell CSGID from the detected femtocell, and compare the one stored in its whitelist. If it matches, then the detected femto-base station is one of the femto-base stations to which MS 116 subscribed. If no matched femtocell is found, MS 116 may repeat the procedure and scan for other preambles indicated in the received list (sent in step 550). If no matched femtocell is found and the received list is exhausted, MS 116 may scan for other cells not in the received list.

The procedure described above can be used to optimize the mobile station search for femtocell(s) belonging to the mobile station desired subscription(s) among all its subscriptions. Instead of blindly scanning and searching for femtocells to which MS 116 is subscribed, the network provides a set of possible accessible femtocells to MS 116. In addition, the mobile station can choose its desired subscription(s) among all its subscriptions, so that the network can further optimize the neighboring femtocell list to satisfy the requirements of MS 116. By sending desired subscription(s), MS 116 does not need to scan every neighboring femto-BS. Instead, MS 116 can scan the neighboring femtocells identified by serving BS 102, which sends MS 116 an optimized neighboring femtocell list. This reduces the overhead of MS 116 scanning for its desired femtocells.

The methods in this disclosure can be combined with other methods which optimizes the search for certain femtocell(s).

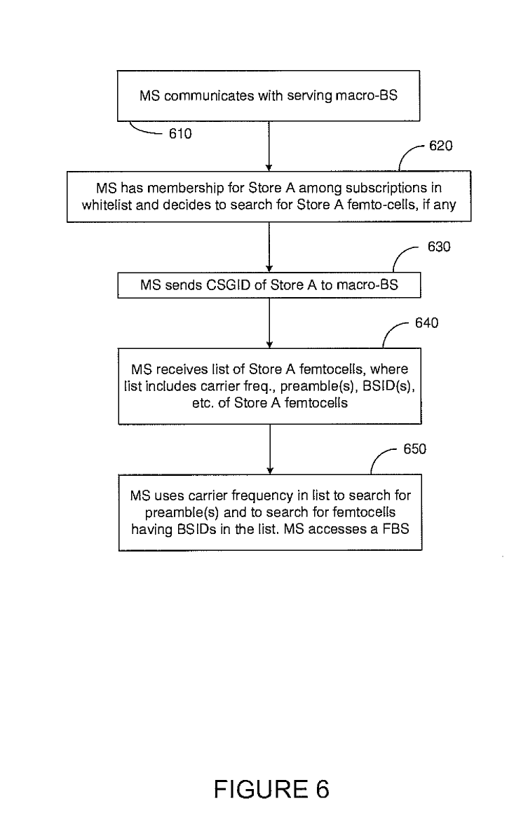

FIG. 6 is a flow diagram illustrating an operation in which mobile station (MS) 116 accesses a femtocell according to an exemplary embodiment of the disclosure. Initially, MS 116 communicates with serving macro-BS 102 (step 610). MS 116 has a membership for Store A among the subscriptions in whitelist 340 and decides to search for Store A femto-cells, if any (step 620). MS 116 sends the CSGID value for Store A to macro-BS 102 (step 630). In response, MS 116 receives from BS 102 a list of Store A femtocells. The list includes, among other things, carrier frequency data, preamble(s) data, and BSID values(s) for Store A femtocells (step 640). MS 116 uses the carrier frequency information in the list to search for FBS preamble(s) and to search for femtocells that have a BSID value in the list. MS 116 then accesses a femto-base station (FBS) (step 650).

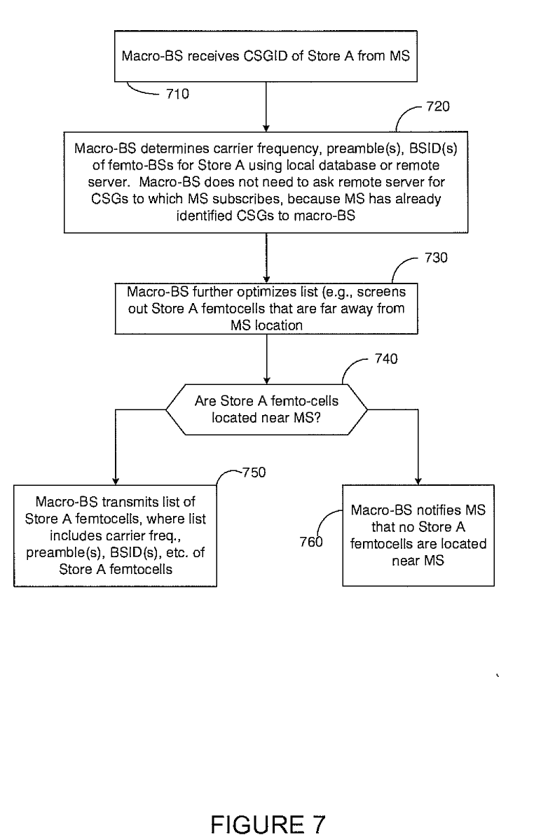

FIG. 7 is a flow diagram illustrating an operation in which macro-base station 102 enables mobile station 116 to access a femtocell according to an exemplary embodiment of the disclosure. Initially, macro-BS 102 receives the CSGID value for Store A (for example) from MS 116 (step 710). In response, macro-BS 102 determines the carrier frequency information, preamble(s), BSID value(s), and the like of femto-BSs for Store A. Macro-BS 102 may determine this information using a local database or via backhaul network, such as by accessing a remote server (or central controller) operated by the network operator. Advantageously, macro-BS 102 does not need to ask the backhaul network or remote server or local database for a list of closed subscriptions groups (CSGs) to which MS 116 subscribes, because MS 116 has already identified such CSGs to macro-BS 102 (step 720).

Macro-BS 102 may then further optimize the list by, for example, screening out Store A femtocells that are far away from the location of MS 116 (step 730). The locations of MS 116 and the femtocells may be needed. Thus, BS 102 determines which Store A femto-cells are located near MS 116 (step 740). If one or more Store A femto-cells are located near MS 116 (“Yes” in step 740), then macro-BS 102 transmits to MS 116 a list of nearby Store A femtocells, where the list includes carrier frequency information, preamble(s), BSID value(s), and the like, of Store A femtocells (step 750). If no Store A femto-cells are located near MS 116 (“No” in step 740), then macro-BS 102 notifies MS 116 that no Store A femtocells are located near MS 116 (step 760), or the macro-BS 102 would simply not suggest any of the femtocells belonging to the desired subscription.

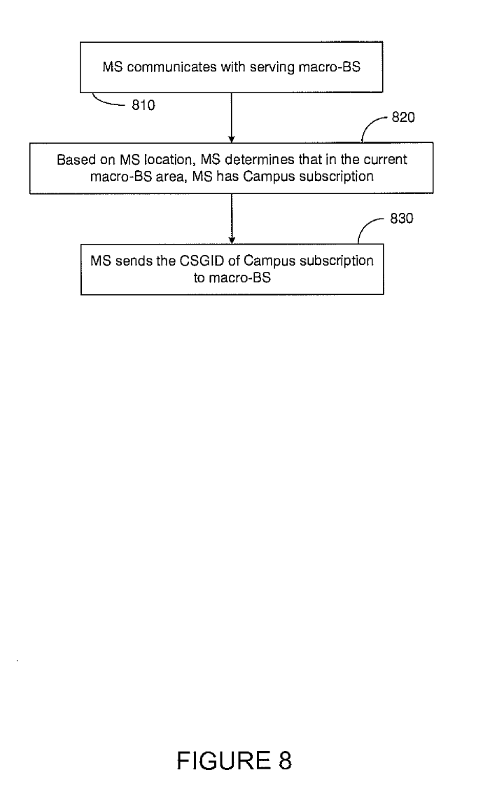

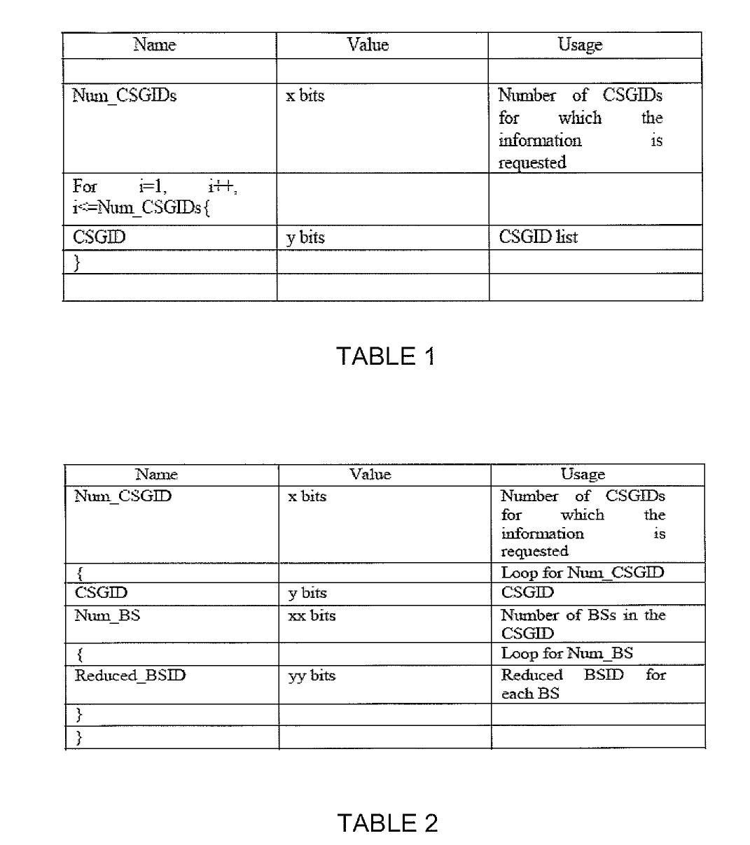

MS 116 may choose subscriptions based on location information. FIG. 8 shows an exemplarily mobile station operation that chooses which CSGIDs in the whitelist are to be sent to the base station according to an exemplary embodiment of the disclosure. In FIG. 8, the flow diagram illustrates an operation in which MS 116 accesses a campus femtocell according to an exemplary embodiment of the disclosure. It is recalled from above that, in a campus-type deployment, a group of femto-base stations that are in the same CSG are co-located with each other, such as FBSs deployed in a large manufacturing facility or a business office. Initially, MS 116 communicates with serving macro-BS 102 (step 810). Based on the location of MS 102, MS 102 determines that, in the current macro-BS 102 serving area, MS 116 has a Campus subscription (step 820). As a result, MS 116 sends the CSGID value of the Campus subscription to macro-BS 102 (step 830). Thereafter, BS 102 may operate as in FIG. 7 above to provide, for example, carrier frequency, preamble(s) and BSID value(s) to MS 116 for the femto-base stations in the campus deployment.

As noted above, mobile station 116 uses the CSGID value to fetch from serving macro-base station 102 information associated with neighboring femto-base stations that are in the same closed subscription group (CSG). Mobile station 116 may request from the serving macro-base station 102 the information for the neighboring femto-base stations by including one or more CSGID values in the request message. Base station 102 may then respond with a list of neighboring femto-base stations that are associated with the requested CSGID values.

As an example, in an IEEE-802.16m system, mobile station 116 may include the CSGID values in the scanning request message (e.g., AAI_SCN-REQ) or in the neighboring cells request message (e.g., AAI_NBR-REQ). As another example, the CSGID values may be in the scanning report message (e.g., AAI_SCN-REP) with an indicator indicating the MS requests an optimized neighbor list. In an exemplary embodiment, these standardized messages are modified to include the CSGID values. For example, the CSGID values may be included as a new data fields in these messages. Serving macro-base station 102 then responds with a list of the femto-base stations associated with the requested CSGID values, where the list can include the information associated to the femtocell in the list, such as the carrier frequency, preamble or cell ID, base station ID (BSID), etc.

TABLE 1 illustrates exemplary data fields that may be added to the AAI_NBR-REQ message, the AAI_SCN-REQ message, and/or the AAI_SCN-REP message with indicator set to indicate the MS requests optimized neighbor list in order to transmit the CSGID values from MS 116 to BS 102. In the message, MS 116 indicates the number of the desired subscriptions from the whitelist and indicates the desired subscription information (e.g., the CSGID of each desired subscription). The exemplary data fields in TABLE 1 are by way of illustration only and should not be construed to limit the scope of the invention.

In another embodiment of the present disclosure, the fields for sending CSGID values in the message can be compressed, based on the construction of the CSGID. CSGID usually is a globally unique logical identifier to indicate the subscription. In some system, CSGIDs may have some common bits. An operator may decide which subscription group to use which CSGID, and the globally unique CSGID can be, for example, a concatenation of the operator identifier (ID) and some further identifier within the operator. Operator ID can be a globally unique identifier to identify the operator. If the CSGID is a concatenation of the operator ID and some further identifier within the operator, then when MS 116 wants to send multiple CSGIDs within one operator, MS 116 may send the operator ID once, together with the multiple further identifiers of the CSG within the operator, so that there is no need to send operator ID for every CSGID MS 116 sends. This reduces overhead.

In another embodiment of the present disclosure, the CSGID and further identifier within the CSGID may be used to uniquely identify the base station. BSID is a unique identifier for a base station. However, using the CSGID and the further identifier within the CSGID may also uniquely identify the base station.

In another embodiment of the present disclosure, when the CSGID and further identifier within the CSGID are used to uniquely identify the base station in some messages, such as the message used by MS 116 to report to the serving BS about the scanning results (e.g., the scanning report message), the fields for the unique identifier of BS 102 may be compressed by including the CSGID once together with the further identifier(s) within the CSGID, when multiple BSs share a common CSGID. In such case, there is no need to send CSGID for every unique identifier.

The CSGID may be independent of the BSID, or may be related to the BSID. Some operator may construct the CSGID based on the BSID. For example, a few most significant bits of the BSID can be the CSGID, and the remaining bits which are less significant bits of the BSID can be the further identifier to identify the femtocell within the CSG. Then, in the message such as scanning report message, when MS 116 wants to use the unique identifiers to report multiple femtocells sharing a common CSGID, MS 116 can send the common CSGID once, followed by multiple further identifiers within the CSG.

In an exemplary embodiment, MS 116 may use the CSGID values(s) to reduce the overhead in the control messages when MS 116 is reporting information about multiple femto-base stations that belong to the same CSG. In such a scenario, MS 116 may include the CSGID value, the number of femto-base stations for the corresponding CSGID value, and then may include just the reduced BSID value for these femto-base stations. MS 116 may generate the reduced BSID value from the bits that are left after removing the CSGID portion from the full BSID value. The reduced BSID value also may be generated by indexing from the CSGID value, or using the difference/distance between the BSID and CSGID values, among other ways.

MS 116 may report multiple CSGID values in this manner. In such a scenario, MS 116 may include the number of CSGID values, as well. When such message is received, BS 102 is able to determine the full BSID value of the femto-base station(s).

The field length in the request message may be further optimized based on the CSGID construction method.

In an exemplary IEEE-802.16m system, MS 116 may report the measurement results of the neighboring base stations belonging to the same CSG in this manner. By way of example, the standard AAI_SCN-REP message may be modified to support this capability. In an exemplary embodiment, the modified AAI_SCN-REP message may include the number of CSGID values, the number of femto-base stations reported for each CSG, and the reduced BSID value for each femto-base station. This is applicable as well to other similar messages that use a field of a full BSID value.

TABLE 2 illustrates exemplary data fields that may be added to the AAI_SCN-REP message. TABLE 2 includes only the relevant exemplary fields in the message. The number of bits (y) for the field of CSGID value may be a fixed length for the maximum possible CSGID length (e.g., 48 bits). The number of the bits (yy) for the Reduced_BSID value may be the maximum possible reduced BSID length (e.g., 24 bits).

If consecutive BSID values are reserved for femto-base stations in the same CSG, then the first BSID value of these reserved consecutive BSID values may be used as the CSGID value. The first BSID value ends with consecutive zeros and the number (n) of such ending consecutive zeros may be used to indicate the number (2̂n) of BSID values associated with the same CSGID value. In such a case, y=48 bits and yy=n in TABLE 2.

In another embodiment of the present disclosure, the CSGID value may be used by BS 102 to report multiple neighboring femto-base stations belonging to same CSG. In this scenario, BS 102 may include the CSGID value and the number of femto-base stations for the corresponding CSGID value. BS 102 may then include just the reduced BSID value for the femto-base stations. The reduced BSID value may be generated from the bits which are left after removing the CSGID portion from the full BSID value. The reduced BSID value also may be generated by indexing from the CSGID value or from the difference/distance between the BSID and CSGID values.

BS 102 may include information about multiple CSGID values in this manner. In such a scenario, BS 102 may include the number of CSGID values. When such message is received, the base station can figure out the full BSID value.

In an exemplary IEEE-802.16m system, BS 102 may indicate the neighboring femto-base stations belonging to the same CSG in this manner. For example, the standard neighbor advertisement message (AAI_NBR-ADV message) may be modified to support this capability. In an exemplary embodiment, the modified AAI_NBR-ADV message may include the number of CSGID values, the number of femto-base stations reported for each CSG and the reduced BSID value for each bemto-base station. This is applicable to other similar messages that used a field of the full BSID value. TABLE 2 illustrates exemplary data fields that may be added to the AAI_NBR-ADV. TABLE 2 includes only the relevant fields in these messages.

In another embodiment of the disclosure, when BS 102 pages mobile station 116, BS 102 may use the CSGID value to indicate all the femto-base stations in the same CSG. When it is necessary to page a member mobile station of the CSG, then BS 102 (or another controller/server) may notify the femto-base stations associated with the CSGID value to page the member mobile station and, in the notifying message, the CSGID value may be used.

BS 102 or a central server/controller may map the CSGID value with the paging group ID. For example, one or multiple CSGID values may be mapped to one or multiple paging group ID values.

In another embodiment of the disclosure, if low duty mode (LDM) femto-base stations in the same CSG are to be woken up, then the CSGID value may be used in the wake-up message to wake up the femto-base stations. The wake-up message includes the CSGID value and may be sent by backhaul or from the mobile station. Upon receiving such a message with the CSGID value, the femto-base stations associated with the CSGID value will wake up.

In an exemplary IEEE-802.16m system, the local white list of a mobile station may contain the allowable BSID values or common identifiers of CSGs and relevant information to help derivation of the allowable BSID values from the common identifier. When a mobile station scans femto-base stations based on the CSG white list, the mobile station may include the common identifier of the designated CSG femto-base stations in the SCN-REQ message. When macro-base station 102 receives the SCN-REQ including BSID value or the common identifier of a CSG, BS 102 may include in the SCN-RSP message the other BSID values belonging to the requested CSG.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless network comprising macro-base stations and femto-base stations, a mobile station comprising:
a transceiver capable of communicating with the macro-base stations and femto-base stations of the wireless network;
a message processor coupled to the transceiver; and
a memory coupled to the message processor that stores a white list of CSGID values associated with at least one closed subscription group to which the mobile station is subscribed,
wherein the message processor is operable to transmit to a first macro-base station a first control message that contains at least one CSGID value from the white list and is further operable to receive from the first macro-base station a second control message that contains the information of at least one femto-base station (FBS) identifier associated with the at least one CSGID value.

2. The mobile station as set forth in claim 1, wherein the mobile station uses the information of at least one FBS identifier to access a first femto-base station associated with the at least one FBS identifier.

3. The mobile station as set forth in claim 1, wherein the first control message is one of: 1) a scanning request message, 2) a neighbor request message, and 3) a scanning report message with an indicator set to be for mobile station request neighbor information.

4. The mobile station as set forth in claim 1, wherein the second control message is one of: 1) a scanning response message and 2) a neighbor list.

5. The mobile station as set forth in claim 1, wherein the information of the at least one FBS comprises at least one of: 1) a carrier frequency, 2) a carrier frequency index, 3) a preamble, 4) a preamble index, 5) a cell ID, 6) a cell ID index, and 7) a BSID and wherein the mobile station uses the information of the at least one FBS identifier to perform cell search for the first FBS.

6. For use in a mobile station that operates in a wireless network comprising macro-base stations and femto-base stations, a method of accessing a first femto-base station comprising the steps of:
retrieving from a memory in the mobile station a white list of CSGID values associated with at least one closed subscription group to which the mobile station is subscribed;
transmit to a first macro-base station a first control message that contains at least one CSGID value from the white list; and
receiving from the first macro-base station a second control message that contains the information of at least one femto-base station (FBS) identifier associated with the at least one CSGID value.

7. The method as set forth in claim 6, wherein the mobile station uses the information of the at least one FBS identifier to access a first femto-base station associated with the at least one FBS identifier.

8. The method as set forth in claim 6, wherein the first control message is one of: 1) a scanning request message, 2) a neighbor request message, and 3) a scanning report message with an indicator set to be for mobile station request neighbor information.

9. The method as set forth in claim 6, wherein the second control message is one of: 1) a scanning response message and 2) a neighbor list.

10. The method as set forth in claim 6, wherein the information of the at least one FBS comprises at least one of: 1) a carrier frequency, 2) a carrier frequency index, 3) a preamble, 4) a preamble index, 5) a cell ID, 6) a cell ID index, and 7) a BSID and wherein the mobile station uses the information of the at least one FBS identifier to perform cell search for the first FBS.

11. For use in a wireless network capable of communicating with a plurality of mobile stations in a coverage area of the wireless network, a macro-base station capable of receiving from a first mobile station a first control message that contains at least one CSGID value from a white list of CSGID values associated with at least one closed subscription group to which the first mobile station is subscribed, wherein the macro-base station, in response to the first control message, is further capable of transmitting to the first mobile station a second control message that contains the information of at least one femto-base station (FBS) identifier associated with the at least one CSGID value.

12. The macro-base station as set forth in claim 11, wherein the mobile station uses the information of the at least one FBS identifier to access a first femto-base station associated with the at least one FBS identifier.

13. The macro-base station as set forth in claim 11, wherein the first control message is one of: 1) a scanning request message, 2) a neighbor request message, and 3) a scanning report message with an indicator set to be for mobile station request neighbor information.

14. The macro-base station asset forth in claim 11, wherein the second control message is one of: 1) a scanning response message and 2) a neighbor list.

15. The macro-base station as set forth in claim 11, wherein the information of the at least one FBS comprises at least one of: 1) a carrier frequency, 2) a carrier frequency index, 3) a preamble, 4) a preamble index, 5) a cell ID, 6) a cell ID index, and 7) a BSID and wherein the mobile station uses the information of the at least one FBS identifier to perform cell search for the first FBS.

16. For use in a macro-base station of a wireless network capable of communicating with a plurality of mobile stations in a coverage area of the wireless network, a method comprising the steps of:
in the macro-base station, receiving from a first mobile station a first control message that contains at least one CSGID value from a white list of CSGID values associated with at least one closed subscription group to which the first mobile station is subscribed; and
in response to the first control message, transmitting from the macro-base station to the first mobile station a second control message that contains the information of at least one femto-base station (FBS) identifier associated with the at least one CSGID value.

17. The method as set forth in claim 16, wherein the mobile station uses the information of the at least one FBS identifier to access a first femto-base station associated with the at least one FBS identifier.

18. The method as set forth in claim 16, wherein the first control message is one of: 1) a scanning request message, 2) a neighbor request message, and 3) a scanning report message with an indicator set to be for mobile station request neighbor information.

19. The method as set forth in claim 16, wherein the second control message is one of: 1) a scanning response message and 2) a neighbor list.

20. The method as set forth in claim 16, wherein the information of the at least one FBS comprises at least one of: 1) a carrier frequency, 2) a carrier frequency index, 3) a preamble, 4) a preamble index, 5) a cell ID, 6) a cell ID index, and 7) a BSID and wherein the mobile station uses the information of the at least one FBS identifier to perform cell search for the first FBS.
